(19) United States
(12) Patent Application Publication
(10) Pub. No.: US 2023/0063387 A1
(43) Pub. Date: Mar. 2, 2023

(54) OPERATION APPARATUS MONITORING SYSTEM AND OPERATION APPARATUS

(71) Applicant: NORITZ CORPORATION, Hyogo (JP)

(72) Inventors: Kazuhiro NISHIMURA, Hyogo (JP); Kenichi NAKAYAMA, Hyogo (JP); Toshihiko HAMAGAMI, Hyogo (JP); Daisuke HIROTA, Hyogo (JP); Hiroyuki KATSURAGAWA, Hyogo (JP); Naoki TSUDA, Hyogo (JP); Yoshifumi ATOBE, Hyogo (JP); Michihiro KANBAYASHI, Hyogo (JP)

(73) Assignee: NORITZ CORPORATION, HYOGO (JP)

(21) Appl. No.: 17/887,516

(22) Filed: Aug. 15, 2022

(30) Foreign Application Priority Data
Aug. 26, 2021 (JP) 2021-137845
Aug. 26, 2021 (JP) 2021-137846

(51) Int. Cl. G05B 19/418; G06F 11/30

(52) U.S. Cl. CPC G05B 19/418; G06F 11/30; G05B 2219/23051

(57) ABSTRACT

An operation apparatus monitoring system includes an operation apparatus as a monitoring target. The operation apparatus includes a control part capable of executing control of acquiring multiple pieces of apparatus information associated with an operation status and periodically transmitting acquired data of the multiple pieces of apparatus information to a monitoring apparatus. In the control part, multiple groups are set, and data of the multiple pieces of apparatus information are grouped to belong to at least one of the multiple groups and are stored. Transmission of data of the multiple pieces of apparatus information to the monitoring apparatus is executed according to a sequence of data transmission to the monitoring apparatus determined for each group.

### CROSS-REFERENCE TO RELATED APPLICATION

This application claims the priority benefit of Japan application serial no. 2021-137845, filed on Aug. 26, 2021 and Japan application serial no. 2021-137846, filed on Aug. 26, 2021. The entirety of the above-mentioned patent applications is hereby incorporated by reference herein and made a part of this specification.

### BACKGROUND

### Technical Field

The disclosure relates to an operation apparatus monitoring system for monitoring a desired operation apparatus such as a hot water supply apparatus, and an operation apparatus thereof.

### Related Art

A specific example of an operation apparatus monitoring system is a system described in Patent Document 1 (Japanese Patent Application Laid-Open No. 2021-64905).

The system includes an operation apparatus (facility apparatus) as a monitoring target, and a monitoring apparatus capable of executing data communication between the operation apparatus. The operation apparatus is capable of acquiring a plurality of pieces of apparatus information associated with an operation status of the operation apparatus. On the other hand, the monitoring apparatus is capable of identifying the plurality of pieces of apparatus information and setting information indicating an update cycle corresponding to the apparatus information. When receiving the information identifying the apparatus information and the information indicating the update cycle from the monitoring apparatus, the operation apparatus acquires the corresponding apparatus information, and then transmits the apparatus information to the monitoring apparatus at the update cycle indicated by the monitoring apparatus.

According to such a configuration, it is possible that only the apparatus information necessary for the monitoring apparatus is selectively received from the operation apparatus. Therefore, it is possible to prevent excessive data communication executed between the monitoring apparatus and the operation apparatus.

However, in the above related art, there is still room for improvement as described below.

That is, in the operation apparatus monitoring system described in Patent Document 1, information identifying a plurality of pieces of apparatus information associated with the operation status of the operation apparatus and information associated with the update cycle are individually defined for each apparatus information in the monitoring apparatus. Therefore, when the amount of the apparatus information is large, the total amount of data to be processed by the monitoring apparatus also increases, and data processing becomes complicated. In addition, the amount of data communication between the monitoring apparatus and the operation apparatus also increases. Therefore, it is desired that such a situation be improved.

On the other hand, another specific example of the operation apparatus monitoring system is a system described in Patent Document 2 (Japanese Patent Application Laid-Open No. 2020-3122).

In the system, a monitoring apparatus determines whether there is a failure sign in the operation apparatus. If it is determined that there is a failure sign, a predetermined notification operation is executed. Therefore, a user of the operation apparatus monitoring system can appropriately take measures to prevent a failure of the operation apparatus.

However, in the operation apparatus monitoring system described in Patent Document 2, there is still room for improvement as described below.

That is, in the operation apparatus monitoring system, based on the data of the operation status of the operation apparatus detected by using a predetermined sensor, it is determined whether there is a failure sign in the operation apparatus. In this case, it is difficult to adopt a method of collecting and learning data at the time of occurrence of an abnormality as a method for determining a failure sign. Therefore, the following determination method is generally used: a normal range is defined by learning the data of the operation status during normal operation of the operation apparatus, and when information deviating from this range is obtained, it is determined that there is an abnormality (failure sign).

However, the conditions for using such a determination method are as follows.

A first condition is that there is a constant periodicity in the usage method and the operation status of the operation apparatus, and the variation is small.

A second condition is that the correlation between the data transmitted from the operation apparatus to the monitoring apparatus is not lost.

A third condition is that apparatus information indicating the operation status can be acquired at a cycle that can accurately capture the abnormal state of the operation apparatus.

If the first and second conditions are not satisfied, only obvious abnormalities can be found. Further, if the third condition is not satisfied, even if an abnormality occurs, it may be overlooked.

Some operation apparatus monitoring systems do not satisfy the first to third conditions described above. For example, a monitoring system in which the operation apparatus is a hot water supply apparatus does not satisfy the first condition. Specifically, in a hot water supply apparatus, for example, when a hot water tap is opened by a user's operation and hot water supply is started, the opening degree of the hot water tap is not constant (the usage method is not constant). The hot water supply flow rate varies greatly depending on the opening degree of the hot water tap. Therefore, in the case where the hot water supply flow rate is treated as the apparatus information, the variation in this value tends to be large, and the first condition is not satisfied. With such an operation apparatus monitoring system, it is difficult to accurately determine a failure sign.

Further, in the case where the operation apparatus is a hot water supply apparatus, excellent responsiveness for quickly converging the hot water supply temperature to a target temperature is required, and the control cycle is short. Therefore, there is a strong tendency for the period of an abnormal (failure sign) state to be shortened. In this case, it is necessary to shorten the acquisition cycle of data of the operation status, but doing so has the disadvantage of increasing the data amount. Further, as high-speed communication is required when transmitting data to the monitoring apparatus, the communication method is also limited.

### SUMMARY

The following technical means are adopted in exemplary embodiments of the disclosure.

An operation apparatus monitoring system provided by a first aspect of the disclosure includes an operation apparatus as a monitoring target, a monitoring apparatus, and a control part. The monitoring apparatus is capable of executing data communication with the operation apparatus. The control part is provided in the operation apparatus and is capable of executing control of acquiring a plurality of pieces of apparatus information associated with an operation status of the operation apparatus and periodically transmitting acquired data of the plurality of pieces of apparatus information to the monitoring apparatus. In the control part, a plurality of groups are set, and data of the plurality of pieces of apparatus information are grouped to belong to at least one of the plurality of groups and are stored. Transmission of data of the plurality of pieces of apparatus information to the monitoring apparatus is configured to be executed according to a sequence of data transmission to the monitoring apparatus determined for each group.

According to an embodiment, the operation apparatus includes at least one detection part for detecting the operation status of the operation apparatus. The control part is configured to be capable of acquiring, as data of the apparatus information, data using the detection part at a predetermined control cycle, and repeatedly execute control of determining whether data of the apparatus information obtained by using the detection part during a predetermined data aggregation period which is a period longer than the control cycle is within a predetermined normal range, creating aggregate data indicating a determination result thereof, and transmitting the aggregate data to the monitoring apparatus. The monitoring apparatus is capable of determining whether there is a failure sign in the operation apparatus based on data transmitted from the operation apparatus.

According to an embodiment, in a case where the data of the apparatus information acquired during the data aggregation period is not within the normal range, the control part is configured to include, in the aggregate data, data of at least one of a count of deviation from inside the normal range to outside the normal range and a duration of deviation to outside the normal range.

According to an embodiment, the control part is capable of executing control of obtaining, as reference data, at least one of a maximum value, a minimum value, an average value, a median value, and a difference with respect to a predetermined reference value in the data of the apparatus information acquired during the data aggregation period, and attaching the reference data to the aggregate data to transmit to the monitoring apparatus.

According to an embodiment, the operation apparatus is a hot water supply apparatus.

An operation apparatus provided by a second aspect of the disclosure includes a data communication part and a control part. The data communication part is capable of executing data communication with a predetermined monitoring apparatus. The control part is capable of executing control of acquiring a plurality of pieces of apparatus information associated with a predetermined operation status and periodically transmitting acquired data of the plurality of pieces of apparatus information to the monitoring apparatus via the data communication part. In the control part, a plurality of groups are set, and data of the plurality of pieces of apparatus information are grouped to belong to at least one of the plurality of groups and are stored. Transmission of data of the plurality of pieces of apparatus information to the monitoring apparatus is configured to be executed according to a sequence of data transmission to the monitoring apparatus determined for each group.

An operation apparatus monitoring system provided by a third aspect of the disclosure includes an operation apparatus as a monitoring target and a monitoring apparatus. The monitoring apparatus is capable of executing data communication with the operation apparatus. The operation apparatus includes at least one detection part for detecting an operation status of the operation apparatus, and a control part capable of executing control of acquiring data of the operation status at a predetermined control cycle by using the detection part and periodically transmitting the data to the monitoring apparatus. The monitoring apparatus is capable of determining whether there is a failure sign in the operation apparatus based on the data transmitted from the operation apparatus. The control part is configured to repeatedly execute control of determining whether data of the operation status obtained by using the detection part during a predetermined data aggregation period which is a period longer than the control cycle is within a predetermined normal range, creating aggregate data indicating a determination result thereof, and transmitting the aggregate data to the monitoring apparatus.

An operation apparatus provided by a fourth aspect of the disclosure includes at least one detection part and a control part. The at least one detection part serves to detect a predetermined operation status. The control part is capable of acquiring data of the operation status at a predetermined control cycle by using the detection part. The control part is configured to repeatedly execute control of determining whether data of the operation status obtained by using the detection part during a predetermined data aggregation period which is a period longer than the control cycle is within a predetermined normal range, creating aggregate data indicating a determination result thereof, and transmitting the aggregate data to a predetermined monitoring apparatus.

Other features and advantages of the disclosure will become more apparent from the following description of embodiments of the disclosure with reference to the accompanying drawings.

### BRIEF DESCRIPTION OF THE DRAWINGS

FIG. 1 is a schematic view showing an example of an operation apparatus monitoring system according to the disclosure.

FIG. 2 is a schematic view showing a hot water supply apparatus as an operation apparatus constituting the operation apparatus monitoring system shown in FIG. 1.

FIG. 3 is a view showing an example of grouped data of apparatus information stored in a storage part of the operation apparatus.

FIG. 4 is a view showing a procedure of acquiring and transmitting data shown in FIG. 3.

FIG. 5 is a flowchart showing an example of an operation process procedure executed in the hot water supply apparatus shown in FIG. 1 and FIG. 2.

FIG. 6 is a flowchart showing an example of an operation process procedure executed in the monitoring apparatus shown in FIG. 1.

FIG. 7 is a view showing an example of data of apparatus information.

FIG. 8 is a flowchart showing an example of a procedure of determining a failure and a failure sign of a fan.

FIG. 9 is a flowchart showing an example of a procedure of determining a failure and a failure sign of a neutralizer.

FIG. 10 is a flowchart showing an example of a procedure of determining a failure and a failure sign of an ignition operation system.

FIG. 11 is a view showing another example of grouped data of apparatus information.

### DESCRIPTION OF THE EMBODIMENTS

Hereinafter, exemplary embodiments of the disclosure will be specifically described with reference to the drawings.

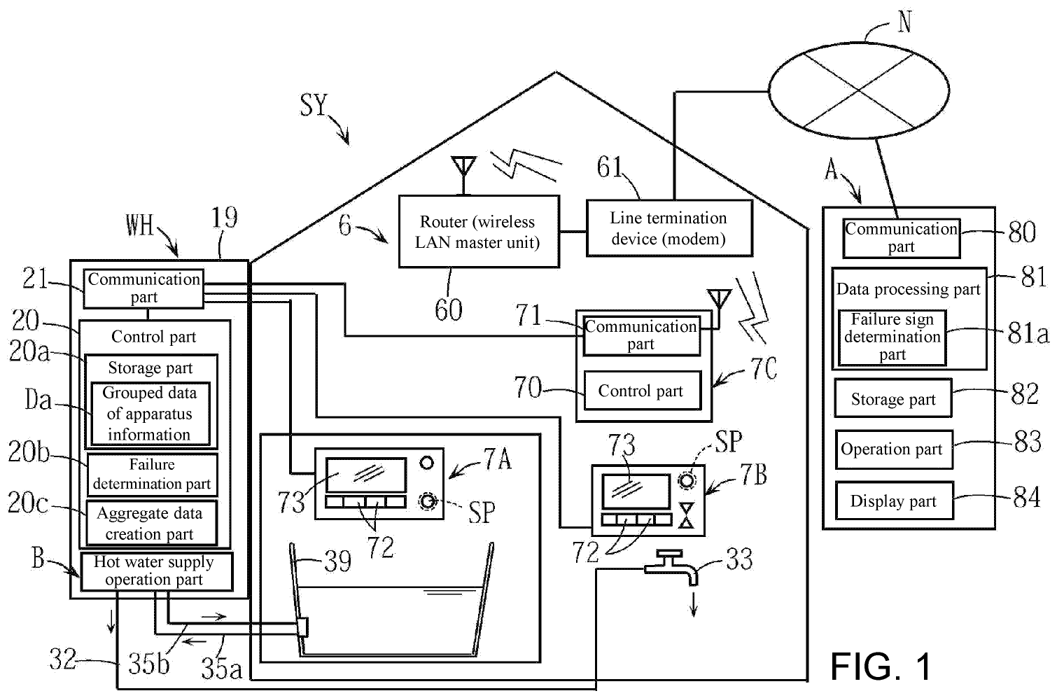

An operation apparatus monitoring system SY shown in FIG. 1 includes a hot water supply apparatus WH and a monitoring apparatus A which monitors the hot water supply apparatus WH. The hot water supply apparatus WH corresponds to an example of an “operation apparatus” taken as a monitoring target as referred to in the disclosure. In addition, the operation apparatus monitoring system SY includes a line termination device 61 (modem) for a communication network N and a router 60 (wireless LAN master unit), which serve as means for constructing a wireless LAN system 6 near the installation location of the hot water supply apparatus WH.

The monitoring apparatus A is a server (computer) connected to the communication network N, and is owned and managed by, for example, a manufacturer, a sales company, or a maintenance company of the hot water supply apparatus WH. The monitoring apparatus A includes a communication part 80, a data processing part 81, a storage part 82, an operation part 83 composed of various operation switches, and a display part 84 capable of displaying data. As will be described later, the monitoring apparatus A receives data of predetermined apparatus information from the hot water supply apparatus WH and performs determination on a failure sign of the hot water supply apparatus WH based on the received data.

The hot water supply apparatus WH is, for example, a gas-type hot water supply apparatus, and as its basic configuration is the same as conventionally known, the configuration of each part will be described relatively briefly. In addition to a hot water supply operation part B capable of performing a general hot water supply to a hot water tap 33 installed in a kitchen and performing a hot water filling supply to a bathtub 39, for example, the hot water supply apparatus WH further includes a control part 20 including a storage part 20a for controlling the hot water supply operation part B, and a communication part 21. Remote controllers 7A and 7B installed in the bathroom and the kitchen and a communication unit 7C are connected by wiring to the communication part 21. Similar to a control part 70 of the communication unit 7C and control parts of the remote controllers 7A and 7B (to be described later), the control part 20 is configured by using a microcomputer and executes data processing and operation control (to be described later).

The remote controllers 7A and 7B include a plurality of operation switches 72 capable of performing data setting such as changing a target hot water supply temperature and performing operations such as a hot water filling start instruction for the bathtub 39, a display part 73 capable of displaying predetermined data such as the target hot water supply temperature, a speaker SP, and a control part (not shown).

The communication unit 7C serves as a slave unit of the wireless LAN system 6 and enables data communication between the control part 20 of the hot water supply apparatus WH and the monitoring apparatus A. The communication unit 7C includes a communication part 71 and a control part 70.

In FIG. 1, the communication unit 7C is a unit installed separately from the remote controllers 7A and 7B. However, it is not limited to such a configuration. For example, the communication unit 7C may also be assembled to or built in at least one of the remote controllers 7A and 7B.

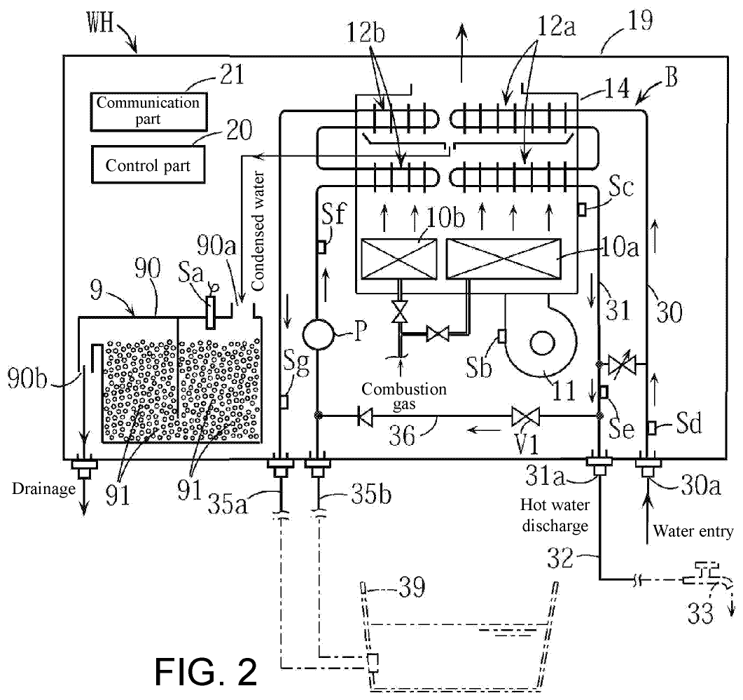

As shown in FIG. 2, the hot water supply operation part B is configured to include, inside an outer case 19, a fan 11, a can body 14 which takes in combustion air from the fan 11, a first burner 10a and a second burner 10b serving as gas burners arranged in the can body 14, a first heat exchanger 12a and a second heat exchanger 12b which recover sensible heat and latent heat from the combustion gas generated by the first burner 10a and the second burner 10b, and a neutralizer 9.

The general hot water supply in the hot water supply operation part B is executed by heating water by the first burner 10a after the hot water tap 33 is opened and water is sent from a water inlet 30a to the first heat exchanger 12a via a piping part 30. The heated hot water reaches a hot water outlet 31a via a piping part 31 and then is supplied to the hot water tap 33 via a hot water outlet piping 32.

The hot water filling to the bathtub 39 is executed by switching an on-off valve V1 of a hot water pouring piping part 36, which is branched and connected to the piping part 31, to an open state. In this case, the hot water flowing from the piping part 31 into the hot water pouring piping part 36 is supplied to the bathtub 39 via piping parts 35a and 35b which constitute a bath reheating circuit.

Bath reheating is executed by driving a circulation pump P provided at the piping part 35b. When the circulation pump P is driven, hot water of the bathtub 39 is sent to the second heat exchanger 12b via the piping part 35b and is heated, and then the hot water is returned to the bathtub 39 via the piping part 35a.

The neutralizer 9 serves to neutralize the strongly acidic condensed water (drain water) generated when latent heat is recovered from the combustion gas by the first heat exchanger 12a and the second heat exchanger 12b. The neutralizer 9 is configured to have a granular neutralizing agent 91 accommodated in a container 90 having, for example, an inlet 90a and an outlet 90b for condensed water.

The hot water supply apparatus WH further includes a plurality of sensors (detection parts) (to be described later) for detecting an operation status of each part. From a functional point of view, the control part 20 includes a failure determination part 20b which determines whether a predetermined failure has occurred in the hot water supply operation part B based on data of apparatus information acquired by using the plurality of detection parts, and an aggregate data creation part 20c which repeatedly creates aggregate data (to be described later) at a predetermined cycle to be transmitted to the monitoring apparatus A. On the other hand, the data processing part 81 of the monitoring apparatus A includes a failure sign determination part 81a which determines whether there is a failure sign in the hot water supply apparatus WH based on the aggregate data transmitted from the hot water supply apparatus WH.

Specific examples of the plurality of sensors provided in the hot water supply apparatus WH include a water level sensor Sa which outputs a predetermined signal for detecting when the neutralizer 9 is clogged and the water level of the condensed water in the neutralizer 9 becomes an abnormal water level exceeding a predetermined level, and a fan rotation speed sensor Sb provided at the fan 11. Other detection parts also include a flame rod (flame sensor, not shown) for determining whether the first burner 10a and the second burner 10b are being driven for combustion, a can body temperature sensor Sc for detecting a temperature of the can body 14, an incoming water temperature sensor Sd, a hot water discharge temperature sensor Se, a bath incoming water temperature sensor Sf, and a bath hot water discharge temperature sensor Sg. In addition to these, various flow rate sensors (not shown) for detecting the flow rate of water and the presence/absence of circulation of water at each part are also provided.

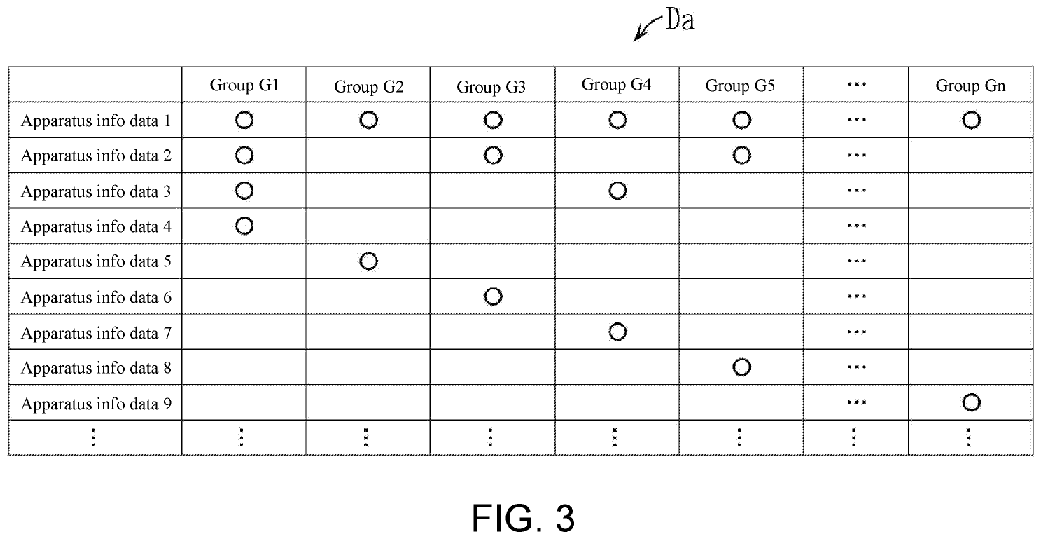

The data of the operation status obtained by using the plurality of sensors Sa to Sg described above corresponds to a specific example of the data of the apparatus information referred to in the disclosure. In the case where the data of the plurality of pieces of the apparatus information are set as data 1, 2, 3, . . . , as shown in FIG. 3, for example, these data are grouped to belong to at least one of a plurality of groups G1 to Gn. Data Da grouped in this manner are stored in the storage part 20a of the control part 20. In the data Da shown in FIG. 3, for example, the data 1 of the apparatus information belongs to any of the groups G1 to Gn, and the data 2 belongs to the odd-numbered groups G1, G3, G5 . . . . In this manner, one type of data may be classified to belong to a plurality of groups.

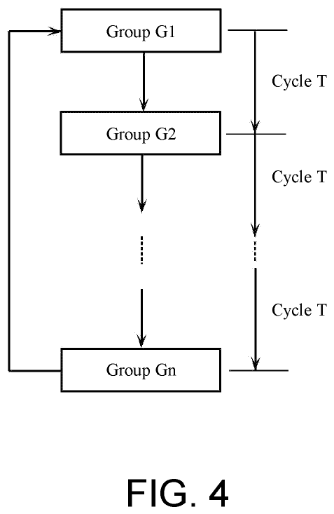

The data of the groups G1 to Gn described above are configured to be transmitted from the hot water supply apparatus WH to the monitoring apparatus A at a substantially constant cycle T according to this group sequence (see FIG. 4). Therefore, the data 1 of the apparatus information shown in FIG. 3 is transmitted to the monitoring apparatus A in each transmission at a substantially constant cycle T. In this embodiment, the aggregate data (to be described later), in place of the data itself of the operation status detected by using the plurality of sensors Sa to Sg, is transmitted from the hot water supply apparatus WH to the monitoring apparatus A.

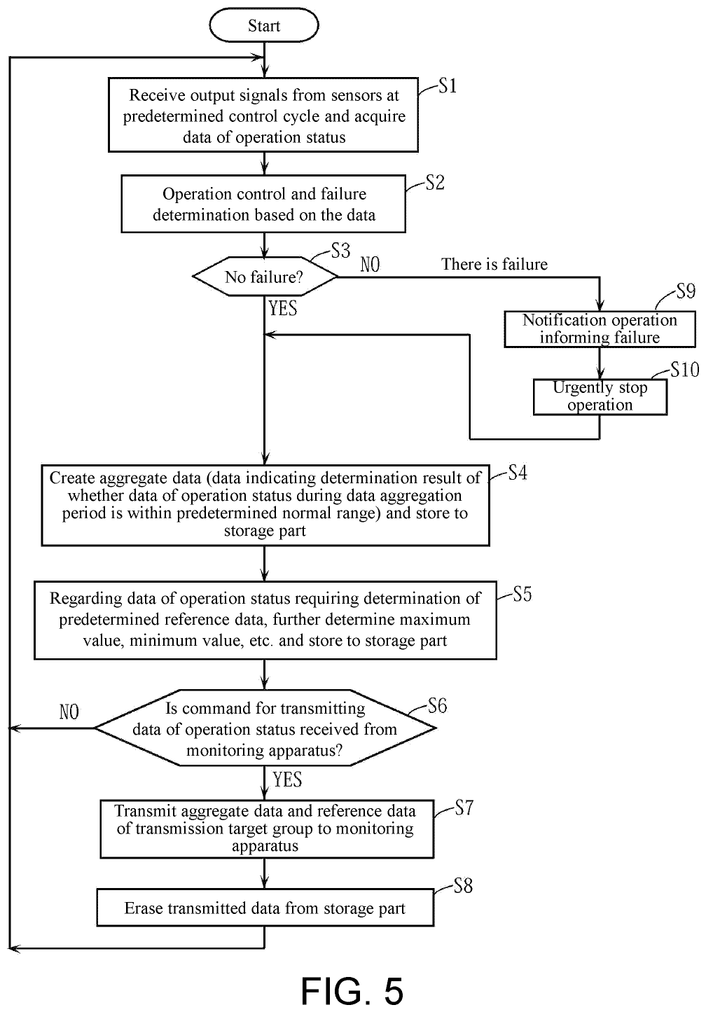

Next, specific examples of an operation procedure in the operation apparatus monitoring system SY described above and the effects will be described with reference to FIG. 5 to FIG. 10.

First, in the hot water supply apparatus WH, the control part 20 receives output signals from the plurality of sensors Sa to Sg at a predetermined control cycle and acquires data of an operation status of each part of the hot water supply apparatus WH. In the control part 20, based on such data, operation control on the hot water supply apparatus WH is executed, and failure determination is performed (S1, S2). The control cycle is, for example, a short cycle of about 0.1 second. Acquisition of data of the operation status described above and a creation process of the aggregate data to be described later are continuously executed regardless of whether the operation switches of the remote controllers 7A and 7B of the hot water supply apparatus WH are turned on or off.

In the determination described above, if it is determined that there is a failure in the hot water supply apparatus WH, a notification operation to that effect is performed, and the operation of the hot water supply apparatus WH is urgently stopped (S3: NO, S9, S10). The notification operation is performed, for example, by displaying data using the display part 73 of the remote controllers 7A and 7B and outputting a predetermined sound from the speaker SP. In a specific example in which it is determined that there is a failure in the hot water supply apparatus WH, as will be described later, in the case where the data of the operation status of the hot water supply apparatus WH is abnormal and it is clearly determined that there is a failure, the operation of the hot water supply apparatus WH is urgently stopped to ensure safety. Although omitted in FIG. 5, in the case where it is determined that there is a failure in the hot water supply apparatus WH, a data to that effect may be transmitted to the monitoring apparatus A. Even after it is determined that there is a failure in the hot water supply apparatus WH and its operation is stopped urgently, the acquisition of the data of the operation status in the hot water supply apparatus WH and the creation process of the aggregate data to be described later are continuously executed.

On the other hand, the control part 20 executes the creation process of the aggregate data at any time based on the acquired data of the operation status, and stores the aggregate data to the storage part 20a (S4). Herein, the creation process of the aggregate data is a process of determining whether the data of a specific operation status during a predetermined data aggregation period Pa is within a predetermined normal range, and creating data (aggregate data) indicating the determination result.

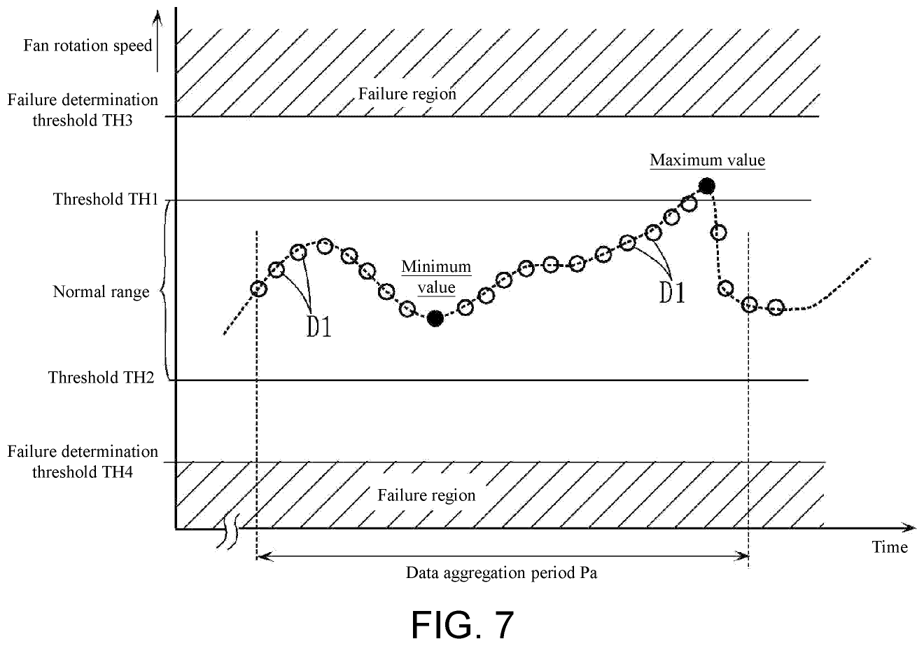

To provide a specific example, FIG. 7 shows an example in which a change in the data D1 of the rotation speed of the fan 11 detected by using the fan rotation speed sensor Sb is taken as the data of the operation status. The data D1 is acquired by the control part 20 at a predetermined control cycle, and the control part 20 determines whether the data D1 acquired during the data aggregation period Pa is within a range of an upper threshold TH1 and a lower threshold TH2, i.e., within a predetermined normal range. The data that indicates the determination result is an aggregate data, and this aggregate data is created. Herein, when a phenomenon in which a previous data D1 exceeds a threshold TH3 or falls below a threshold TH4 for failure determination has occurred, and the phenomenon has continued for a predetermined time Ta or more, it is determined that the fan 11 has failed.

Since the data D1 shown in FIG. 7 exceeds the upper threshold TH1 once, it is determined that the data of the rotation speed of the fan 11 is not within the normal range. However, in this embodiment, in addition to this, a content that the rotation speed of the fan 11 exceeds the upper threshold TH1 once is also taken as the aggregate data. This aggregate data is temporarily stored in the storage part 20a and is simply set to “1”, for example, and if the threshold TH1 is exceeded twice, it is set to “2”, for example. On the other hand, when the lower threshold TH2 is exceeded once or twice, the aggregate data is set to “−1” or “−2”. When the data D1 is all within the normal range, the aggregate data is set to “0”. Of course, the aggregate data referred to in the disclosure may be expressed differently from the above. For example, the number of times the upper threshold TH1 is exceeded and the number of times the lower threshold TH2 is exceeded may be counted, and the counts may be included in the aggregate data.

Regarding the data D1 of the rotation speed of the fan 11, a maximum value and a minimum value during the data aggregation period Pa are also determined, and these data are stored as reference data to the storage part 20a in a form attached to the aggregate data described above (S5).

In the above description, the data D1 of the rotation speed of the fan 11 has been provided as a specific example of the data of the operation status; however, regarding data of the operation status other than the data D1, the control part 20 also creates and stores aggregate data for data of an operation status specified in advance. In addition, regarding data of an operation status which has been additionally specified (further specified), data of values indicating features of the data, such as a maximum value and a minimum value, are obtained and stored as reference data. In addition to the maximum value and the minimum value, an example of the reference data may be an average value, a median value, or a difference with respect to a predetermined reference value (threshold).

On the other hand, when receiving a command from the monitoring apparatus A to transmit the data of the operation status, the control part 20 transmits the aggregate data and the reference data (aggregate data and reference data created and stored in the storage part 20a at this time) of a transmission target group to the monitoring apparatus A (S6: YES, S7). Herein, the transmission target group is the group G1 for the first time and is then sequentially changed to the groups G2, G3, . . . .

When the data transmission above is completed, the transmitted data is erased from the storage part 20a, and afterwards, the series of operation processes described above are repeatedly executed (S8, S1). That is, with the transmission of the aggregate data to the monitoring apparatus A, in the hot water supply apparatus WH, the data for which transmission has been completed is reset, and a creation process of new aggregate data is started. Such a creation process of aggregate data is repeatedly executed regardless of whether the operation of the hot water supply apparatus WH is turned on or off. In the case where a communication error occurs and the data transmission to the monitoring apparatus A cannot be appropriately performed, the aggregate data is stored in the storage part 20a until the next transmission period.

On the other hand, in the monitoring apparatus A, the following operation process is executed.

That is, in the monitoring apparatus A, a timekeeping operation is executed (S21), and when a predetermined time (cycle T) is counted up, a command requesting the data transmission corresponding to step S6 above is transmitted to the hot water supply apparatus WH (S22: YES, S23). On the other hand, in response to such a request, aggregate data and reference data of a predetermined group are transmitted from the hot water supply apparatus WH. When receiving such data, the monitoring apparatus A stores these data to the storage part 82 (S24: YES, S25). Next, based on these data, it is determined whether there is a failure sign of the hot water supply apparatus WH (S26).

The above determination will be described below with some specific examples.

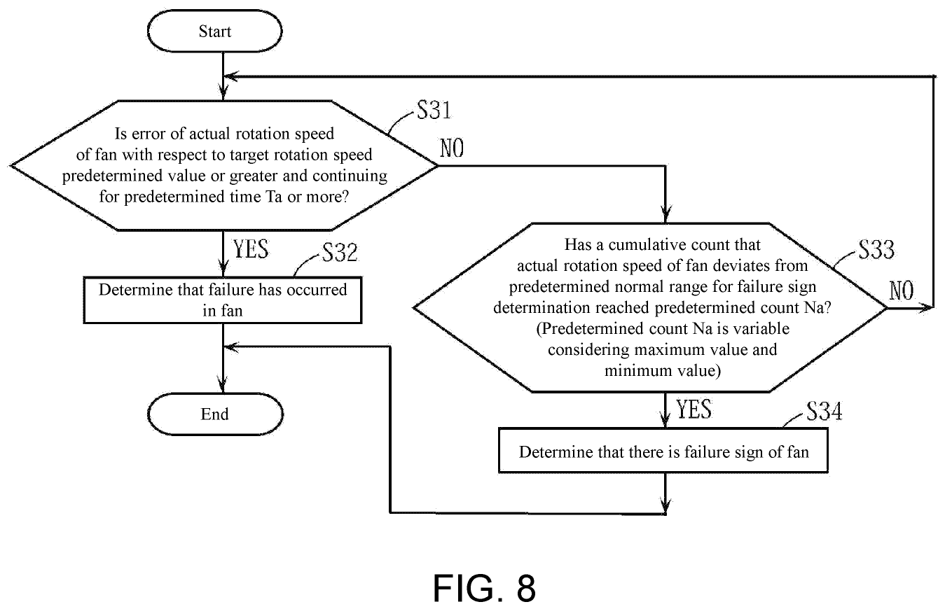

FIG. 8 shows a procedure in the case where the data of the operation status is data associated with the rotation speed of the fan 11.

It has been described above that the failure determination on the fan 11 is performed based on the thresholds TH3 and TH4 shown in FIG. 7. However, more accurately, in the case where an error of an actual rotation speed of the fan 11 with respect to a target rotation speed of the fan 11 increases to a predetermined value or greater and this state has continued for a predetermined time Ta or more, it is determined that a failure has occurred in the fan 11 (S31: YES, S32 in FIG. 8). As described above, this determination is performed by the control part 20 of the hot water supply apparatus WH.

On the other hand, in the case where it is not determined that a failure has occurred in the fan 11, based on the aggregate data, the monitoring apparatus A determines whether a cumulative count that the rotation speed of the fan 11 deviates from a normal range for failure sign determination (the range between the thresholds TH1 to TH2 in FIG. 7) has reached a predetermined count Na (S31: NO, S33). If the cumulative count has reached the predetermined count Na, it is determined that there is a failure sign of the fan 11 (S33: YES, S34).

However, at the time of the determination above, it is possible to change (correct) the value of the predetermined count Na by referring to the reference data indicating the maximum value, the minimum value, etc. of the rotation speed of the fan 11. For example, in the case where the rotation speed of the fan 11 is slightly higher than the target rotation speed, when the maximum value of the rotation speed is large, it is possible to make a change such that the predetermined count Na is reduced to a smaller count than when the maximum value is small.

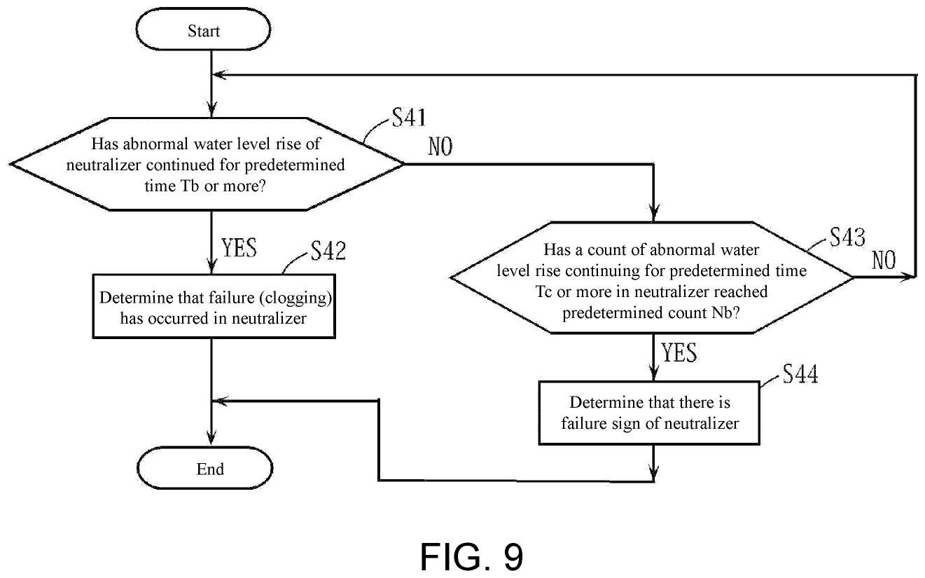

FIG. 9 shows a procedure in the case where the data of the operation status is data associated with an abnormal water level rise of the neutralizer 9 detected by using the water level sensor Sa.

When an abnormal water level rise of the neutralizer 9 is detected by using the water level sensor Sa and this state has continued for a predetermined time Tb or more, in the control part 20, it is determined that a failure (clogging) has occurred in the neutralizer 9 (S41: YES, S42). On the other hand, in the case where it is not determined that a failure has occurred in the neutralizer 9, based on the aggregate data, the monitoring apparatus A determines whether a count of occurrences of an abnormal water level rise continuing for a predetermined time Tc (shorter than the predetermined time Tb) or more in the neutralizer 9 has reached a predetermined count Nb

(S41: NO, S43). The aggregate data is data indicating the count of occurrences of an abnormal water level rise that has continued for the predetermined time Tc or more in the neutralizer 9. If the count of the abnormal water level rise has reached the predetermined count Nb, it is determined that there is a failure sign of the neutralizer 9 (S43: YES, S44).

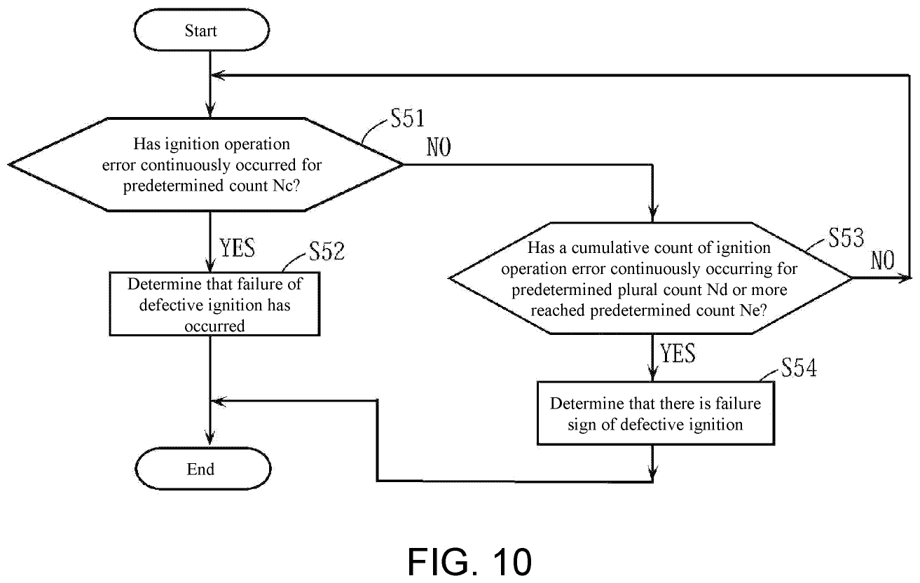

FIG. 10 shows a procedure in the case where the data of the operation status is data associated with an ignition operation error detected by using the flame rod.

The control part 20 of the hot water supply apparatus WH may control an operation of driving a spark plug (not shown) to ignite the first burner 10a and the second burner 10b, and at this time, determines presence/absence of ignition by using the flame rod. If an ignition operation error is repeated, the control part 20 may further determine a count of the ignition operation error. In the case where the ignition operation error has continuously repeated for a predetermined count Nc, in the control part 20, it is determined that a failure of defective ignition has occurred (S51: YES, S52). On the other hand, if such determination is not made, based on the aggregate data, the monitoring apparatus A determines whether a cumulative count that the ignition operation error has continuously occurred for a predetermined plural count Nd (smaller than the predetermined count Nc) has reached a predetermined count Ne (S51: NO, S53). The aggregate data is data indicating the count that the ignition operation error has continuously occurred for the predetermined plural count Nd. If the cumulative count has reached the predetermined count Ne, it is determined that there is a failure sign of defective ignition (S53: YES, S54).

In the hot water supply apparatus WH, in addition to the above, other cases determined as a failure further include the following cases, for example.

(1) A phenomenon in which flame is suddenly extinguished during drive combustion of the first burner 10a and the second burner 10b occurs for a predetermined count or more.

(2) A maximum flame temperature of the first burner 10a and the second burner 10b at the time of drive combustion in a predetermined stage is lower than an original temperature by a predetermined temperature or more.

(3) A phenomenon in which a pump discharge amount does not increase to a predetermined flow rate or higher after a predetermined time has elapsed since the circulation pump P is driven on occurs for a predetermined count or more.

(4) A phenomenon in which an error of an actual hot water supply temperature with respect to a hot water supply target temperature increases to a predetermined value or greater occurs for a predetermined count or more.

(5) Regardless of the hot water supply target temperature, an event in which an actual hot water supply temperature is in a high temperature range exceeding a predetermined temperature occurs for a predetermined count or more.

(6) An event in which a temperature of the can body 14 is in a high temperature range exceeding a predetermined temperature occurs for a predetermined count or more.

(7) A water flow rate [L/sec] exceeds a predetermined flow rate.

(8) A cumulative count of communication error occurs for a predetermined count or more.

In contrast to the failure determination above, the determination on presence/absence of a failure sign is performed by taking, as a condition, a criterion looser than the conditions above for determining a failure, that is, a criterion (tolerance range) of considering to have a high probability of failure in the near future, although currently not yet a failure. However, different from such determination, for example, in the case where a cumulative count of the hot water supply operation has reached a predetermined count, in the case where a cumulative flow of water flowing through the hot water supply apparatus WH has reached a predetermined flow, or in the case where a cumulative combustion time of the first burner 10a and the second burner 10b has reached a predetermined time, it is also possible to take, as a criterion for determining presence/absence of a failure sign, the fact that the endurance life of the hot water supply apparatus WH is expiring and the probability that a failure will occur in the hot water supply apparatus WH is considered to have increased.

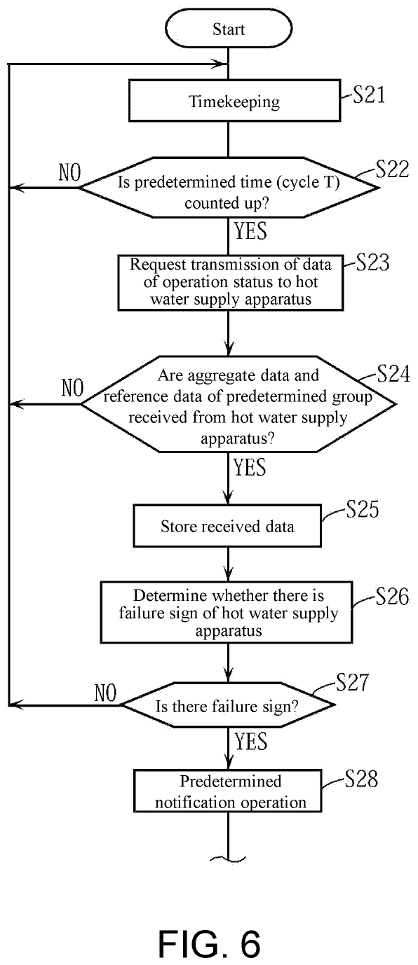

As a result of the above determination on presence/absence of a failure sign, if it is determined that there is a failure sign, a predetermined notification operation is executed (S27: YES, S28 in FIG. 6). This notification operation is executed, for example, in the monitoring apparatus A. Accordingly, a person monitoring the hot water supply apparatus WH by using the monitoring apparatus A can accurately detect that there is a predetermined failure sign in the hot water supply apparatus WH and take appropriate measures to prevent a failure from occurring in the hot water supply apparatus WH. A data indicating that there is a failure sign may be transmitted from the monitoring apparatus A to the hot water supply apparatus WH to also perform a notification operation in the hot water supply apparatus WH. Accordingly, a user of the hot water supply apparatus WH can quickly and accurately detect that there is a failure sign, and it is possible to more appropriately avoid the failure of the hot water supply apparatus WH.

According to the series of operation process procedures described above, the following effects can be obtained.

That is, the data of the plurality of pieces of the apparatus information (data of the operation status) to be used in determination on a failure sign in the monitoring apparatus A are classified into a plurality of groups G1 to Gn, and are acquired for each group in a predetermined sequence and transmitted to the monitoring apparatus A. Therefore, for example, different from Patent Document 1 above, in the monitoring apparatus A, the data transmission process described above is easy, without the need to identify a plurality of pieces of apparatus information, individually determine and store the information associated with the update cycle, and then transmit the information to the operation apparatus (hot water supply apparatus WH). Further, according to this embodiment, while it is necessary to group the data of the plurality of pieces of the apparatus information to belong to at least one of the plurality of groups G1 to Gn, such a process is also easy, and even if the amount of the apparatus information is considerably large, it is possible to easily and appropriately deal with it and group the apparatus information. Therefore, it is possible to facilitate and simplify data processing in the entire operation apparatus monitoring system SY, reduce the amount of data communication, and preferably reduce running costs.

Further, according to this embodiment, in the monitoring apparatus A, it is possible to determine whether there is a failure sign in the operation apparatus (hot water supply apparatus WH), which is conducive to preventing a failure of the hot water supply apparatus WH. In addition to this, the following effects can be further obtained. That is, the data transmitted from the hot water supply apparatus WH to the monitoring apparatus A is set as aggregate data indicating a determination result of whether the data of the apparatus information acquired during the data aggregation period Pa is within a predetermined normal range. Therefore, in the monitoring apparatus A, it is possible to appropriately determine whether there is a failure sign in the hot water supply apparatus WH based on the aggregate data. When compared with the data of the apparatus information itself acquired at a predetermined control cycle, the aggregate data has a reduced total data amount and more accurately indicates the content or tendency of the operation status. Therefore, even if the control cycle of the hot water supply apparatus WH is short and the variation in the data of the operation status is large, it is possible to appropriately perform detection of a failure sign while effectively suppressing an increase in the data amount transmitted from the hot water supply apparatus WH to the monitoring apparatus A.

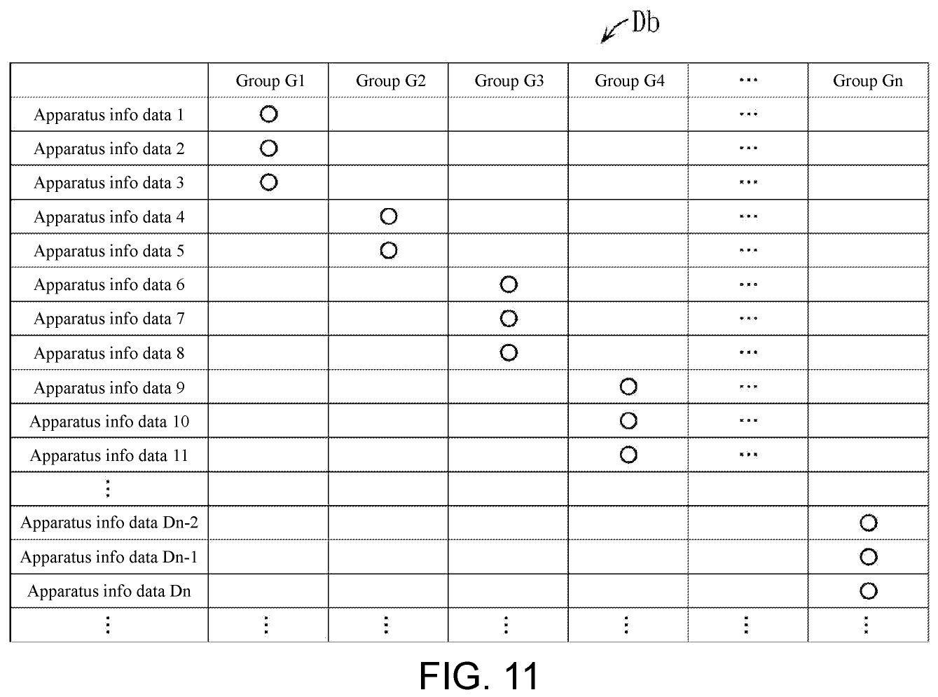

In grouped data Db shown in FIG. 11, a plurality of data 1, 2, 3 . . . of apparatus information are classified to belong to only one group among groups G1 to Gn. Different from the data Da shown in FIG. 3, there is no data belonging to a plurality of groups. In the disclosure, such a configuration is also possible.

The disclosure is not limited to the contents of the embodiments described above. The specific configuration of each part of the operation apparatus monitoring system and the operation apparatus according to the disclosure may be redesigned in various manners within the scope of the disclosure.

In the embodiments above, with the monitoring apparatus A periodically transmitting a command to the hot water supply apparatus WH to request data transmission, the data of predetermined apparatus information is correspondingly acquired in the hot water supply apparatus WH and transmitted to the monitoring apparatus A, but the disclosure is not limited thereto. It is also possible that the transmission period of the data of the apparatus information from the hot water supply apparatus WH to the monitoring apparatus A is configured to be determined in the hot water supply apparatus WH.

In the embodiments above, the monitoring apparatus A is caused to perform determination on presence/absence of a failure sign of the hot water supply apparatus WH, but such determination is not always necessary. However, if the determination on presence/absence of a failure sign is performed, since the specific content of the failure sign and its determination criterion are matters that can be appropriately determined in advance, they are not limited to those provided as specific examples in the embodiments above. The detection parts for acquiring apparatus information are not limited to the sensors described above.

The length of the data aggregation period does not have to be constant but may be indefinite. Further, the length of the data aggregation period may be different depending on the type of data. In the embodiments above, the control part 20 of the hot water supply apparatus WH is configured to perform a creation process of aggregate data; however, in place of or in addition to the control part 20, for example, the control parts provided in the remote controllers 7A and 7B may also be configured to execute the above process. Further, the control part 70 of the communication unit 7C may also be configured to be used in the above process.

The operation apparatus as referred to in the disclosure is not limited to the hot water supply apparatus, but may be various other apparatuses/machines such as a bathroom dryer and a fan heater. When the operation apparatus is a hot water supply apparatus, an oil-type hot water supply apparatus or a hot water storage tank-type hot water supply apparatus may also be used in place of the gas-type hot water supply apparatus.

What is claimed is:

1. An operation apparatus monitoring system comprising:
an operation apparatus as a monitoring target;
a monitoring apparatus capable of executing data communication with the operation apparatus; and
a control part which is provided in the operation apparatus and is capable of executing control of acquiring a plurality of pieces of apparatus information associated with an operation status of the operation apparatus and periodically transmitting acquired data of the plurality of pieces of apparatus information to the monitoring apparatus,
wherein in the control part, a plurality of groups are set, and data of the plurality of pieces of apparatus information are grouped to belong to at least one of the plurality of groups and are stored, and
transmission of data of the plurality of pieces of apparatus information to the monitoring apparatus is configured to be executed according to a sequence of data transmission to the monitoring apparatus determined for each group.

2. The operation apparatus monitoring system according to claim 1, wherein the operation apparatus comprises at least one detection part for detecting the operation status of the operation apparatus,
the control part is configured to be capable of acquiring, as data of the apparatus information, data using the detection part at a predetermined control cycle, and repeatedly execute control of determining whether data of the apparatus information obtained by using the detection part during a predetermined data aggregation period which is a period longer than the control cycle is within a predetermined normal range, creating aggregate data indicating a determination result thereof, and transmitting the aggregate data to the monitoring apparatus, and
the monitoring apparatus is capable of determining whether there is a failure sign in the operation apparatus based on data transmitted from the operation apparatus.

3. The operation apparatus monitoring system according to claim 2, wherein in a case where the data of the apparatus information acquired during the data aggregation period is not within the normal range, the control part is configured to include, in the aggregate data, data of at least one of a count of deviation from inside the normal range to outside the normal range and a duration of deviation to outside the normal range.

4. The operation apparatus monitoring system according to claim 2, wherein the control part is capable of executing control of obtaining, as reference data, at least one of a maximum value, a minimum value, an average value, a median value, and a difference with respect to a predetermined reference value in the data of the apparatus information acquired during the data aggregation period, and attaching the reference data to the aggregate data to transmit to the monitoring apparatus.

5. The operation apparatus monitoring system according to claim 1, wherein the operation apparatus is a hot water supply apparatus.

6. An operation apparatus comprising:
a data communication part capable of executing data communication with a predetermined monitoring apparatus; and
a control part capable of executing control of acquiring a plurality of pieces of apparatus information associated with a predetermined operation status and periodically transmitting acquired data of the plurality of pieces of apparatus information to the monitoring apparatus via the data communication part,
wherein in the control part, a plurality of groups are set, and data of the plurality of pieces of apparatus information are grouped to belong to at least one of the plurality of groups and are stored, and
transmission of data of the plurality of pieces of apparatus information to the monitoring apparatus is configured to be executed according to a sequence of data transmission to the monitoring apparatus determined for each group.

7. An operation apparatus monitoring system comprising:
an operation apparatus as a monitoring target; and
a monitoring apparatus capable of executing data communication with the operation apparatus,
wherein the operation apparatus comprises at least one detection part for detecting an operation status of the operation apparatus, and a control part capable of executing control of acquiring data of the operation status at a predetermined control cycle by using the detection part and periodically transmitting the data to the monitoring apparatus,
the monitoring apparatus is capable of determining whether there is a failure sign in the operation apparatus based on the data transmitted from the operation apparatus, and
the control part is configured to repeatedly execute control of determining whether data of the operation status obtained by using the detection part during a predetermined data aggregation period which is a period longer than the control cycle is within a predetermined normal range, creating aggregate data indicating a determination result thereof, and transmitting the aggregate data to the monitoring apparatus.
